(19) United States
(12) Patent Application Publication
(10) Pub. No.: US 2005/0001383 A1
(43) Pub. Date: Jan. 6, 2005

(54) Device for treating a material

(76) Inventors: Jorg M List, Portalban (CH); Alfred Kunz, Witterswil (CH)

Correspondence Address: BACHMAN & LAPOINTE, P.C., 900 CHAPEL STREET, SUITE 1201, NEW HAVEN, CT, 06510, US

(21) Appl. No.: 10/493,732

(22) PCT Filed: Oct. 16, 2002
(86) PCT No.: PCT/EP02/11579

(30) Foreign Application Priority Data
Oct. 31, 2001 (DE) 101 53 293.8

(51) Int. Cl. F16J 15/26

(52) U.S. Cl. 277/532

(57) ABSTRACT

A device for treating a material in a housing chamber, by means of working elements arranged on a shaft enclosed with a packing box. The packing box comprises at least a sealing casing which presses on at least a compression packing. The sealing casing is pushed against the compression packing parallel to the axis of the shaft with adjustable pressure.

### BACKGROUND OF THE INVENTION

The invention relates to an appliance for a treatment of a material in a space of a housing by means of working elements which are arranged on a shaft surrounded by a stuffing box having at least one packing housing which presses onto at least one packing stack, the packing element being capable of being acted upon axially parallel to the shaft by a regulatable pressure with respect to the packing stack, and the packing housing having connected to it a regulatable force accumulator for acting upon the packing element axially parallel to the shaft by a regulatable pressure with respect to the packing stack.

In a large number of technical sectors, a shaft is held overall or via a shaft journal in a bearing in which the shaft rotates. There are usually also in this case shaft leadthroughs through a packing housing, the intention being for these leadthroughs to prevent a material from passing, for example, out of the space in which the shaft rotates outwardly via the packing.

Floating packings of this type are exposed to diverse forces which subject the packing elements to stress and to wear. In the event of wear, the corresponding packing element must be easily replaceable.

Above all, radial, torsional and axially acting forces must be mentioned as forces which act on such a floating packing.

The present invention relates, overall, but in no way exclusively, to what may be referred to as mixing kneaders for the mechanical and/or thermal treatment of products in the liquid, pasty or pulverulent state, with or without the supply and discharge of gases and/or vapors, with a housing and a shaft which rotates in the housing about an axis of rotation and on which kneading elements are provided so as to be distributed in the axial direction. For example, a mixing kneader of this type is described in EP 0 422 454 D1. The shaft together with the kneading elements is supported via shaft journals in what are known as rolling bearings, in which at least one pack of packing material is inserted between the shaft, the dynamic part, and the housing, the static part, in a packing housing and is compressed, with the result that the packing pack fits snugly against the sliding surface in a leaktight manner.

Packing housings of this type must be mounted flexibly, in order to absorb shaft movements. This has taken place hitherto via corresponding concertina connections between the packing housing and the static part, but these concertina connections are likewise exposed to considerable wear and in the course of time break apart due to fatigue.

In order to achieve the stuffing box effect, pressure must be exerted on the packing pack via the packing housing. This is carried out nowadays either via tension screws or else, for example, via cup springs. The former are adjusted according to the know-how of the appliance operator, in so far as this seems necessary. However, they in no way react to thermal expansion or a reduction in volume during cooling. Accordingly, the pressure exerted on the packing pack is always different, so that there is not only increased wear, but also considerable leakages occur.

Where cup springs are concerned, the preset force is completely the same, so that these, too, cannot allow for different requirements as regards thermal expansion or a reduction in volume during cooling.

Appliances in which pressure is exerted on a packing stack via a force accumulator are known, for example, from GB 2 026 628, FR 2 347 588, U.S. Pat. No. 1,649,472 and U.S. Pat. No. 5,090,711.

It is known from U.S. Pat. No. 4,412,747 and, in particular, from U.S. Pat. No. 3,282,592 that a lever arm is acted upon by pressure via a force accumulator which may be driven pneumatically, this lever arm transmitting the pressure to the packing stack.

The object of the present invention is to provide an appliance of the above-mentioned type, wherein the packing of the stuffing box is appreciably improved.

### SUMMARY OF THE INVENTION

The foregoing object is achieved wherein the force accumulator is connected to the packing housing via a cable pull, the cable pull being led via one or more deflecting rollers in the manner of a block and tackle, and a deflecting roller being arranged in such a way that the pull takes place axially parallel to the axis of the shaft.

By way of the foregoing, different requirements can be taken into account by means of the regulatable pressure. It is preferred that the packing pack is acted upon exactly by the same pressure, irrespective of whether its volume increases due to thermal expansion or is reduced due to cooling. This means that a pneumatic force accumulator should be provided, which, in the case of thermal expansion, for example, prevents a pressure rise by the expansions being compensated. The same applies when the volume of the pack is reduced during cooling, here too, the pressure of the force accumulator remaining constant.

The force accumulator is preferably a pneumatically driven cylinder, but a hydraulic cylinder or even an electromotive force accumulator may also be envisaged. However, a pneumatically driven cylinder is preferred.

Since considerable pressure must nevertheless be exerted on the packing housing, the cable pull is to be guided via one or more deflecting rollers in the manner of a block and tackle. The force requirement to be met by the cylinder is thereby reduced.

So that the packing housing does not tilt under the axially parallel action of pressure, it proves advisable to arrange opposite the one cable pull a further flexible element of a corresponding type, which is connected either to the same pneumatic cylinder as the cable pull or else to its own pneumatic cylinder which is connected pneumatically in parallel.

In another exemplary embodiment of the invention, a single cable pull may be articulated with its ends to the packing housing on both sides. It is then led via a deflection which is assigned to the pneumatic cylinder. Many possibilities which are to be covered by the present invention may be envisaged here.

By virtue of the present invention, the service life of a stuffing box is appreciably improved. It must be emphasized that no overpressing, such as occurs, for example, during the mechanical tightening of tension screws, takes place. Always exactly the same pressure is applied to the packing pack.

It must be emphasized, furthermore, that the entire pulling or pressing device may be arranged well away from the actual stuffing box, so that it is not affected by the increased temperatures in this region. It is less sensitive to corrosion and is more maintenance-friendly.

### BRIEF DESCRIPTION OF THE DRAWINGS

Further advantages, features and details of the invention may be gathered from the following description of preferred exemplary embodiments and from the drawing in which:

FIG. 1: shows a partially sectionally illustrated side view of part of an appliance according to the invention for the treatment of a material;

FIG. 2: shows a rear view, illustrated enlarged, of a further exemplary embodiment of an appliance for the treatment of a material.

### DETAILED DESCRIPTION

An appliance of this type may be, for example, what may be referred to as a mixing kneader, such as is described in EP 0 517 068 B1. They serve, in particular, for the treatment of highly viscous pasty products, using a mechanical, chemical and/or thermal process carried out by means of corresponding working elements, in particular by means of kneading and transport elements. These elements are arranged on a shaft 1 which, in the present case, is indicated merely by dashes. This shaft 1 rotates in a bearing sleeve 2 which also has adjoining it the housing, not shown in any more detail, in which is formed the space in which the material is treated.

The shaft 1 is sealed off with respect to the bearing sleeve 2 by means of a packing stack of a stuffing box. A packing housing 4 presses onto this packing stack 3 and exerts the pressure necessary for a stuffing box. For this purpose, the packing housing 4 is connected via at least one cable pull 5 to a piston rod 6 of a pneumatically driven cylinder 7. The cable pull 5 is led via a deflecting roller 8 which is provided near the cylinder 7. A further deflection takes place via a deflecting roller 9 which is provided rotatably on the bearing sleeve 2.

The connection of the cable pull 5 both to the packing housing 4 and to the piston rod 6 takes place via corresponding joints 10 and 11.

The present invention functions as follows:

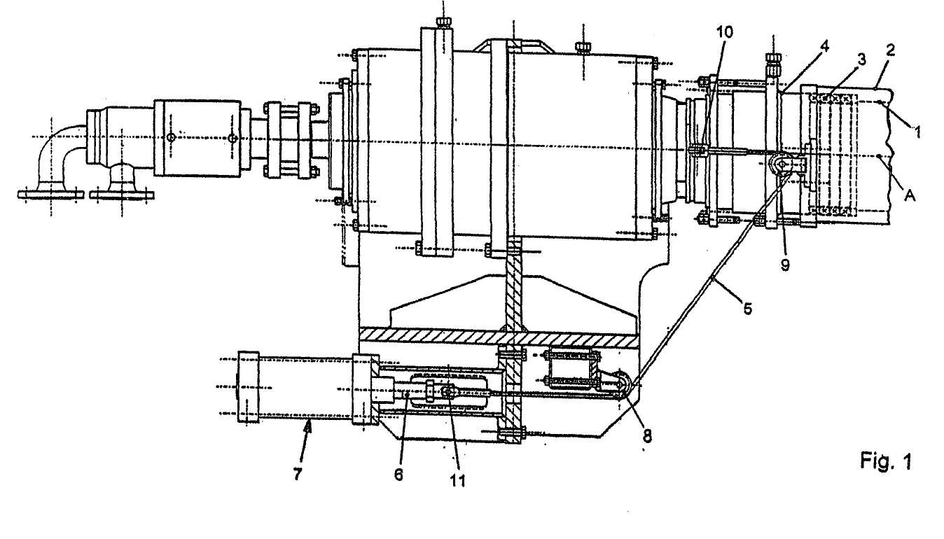

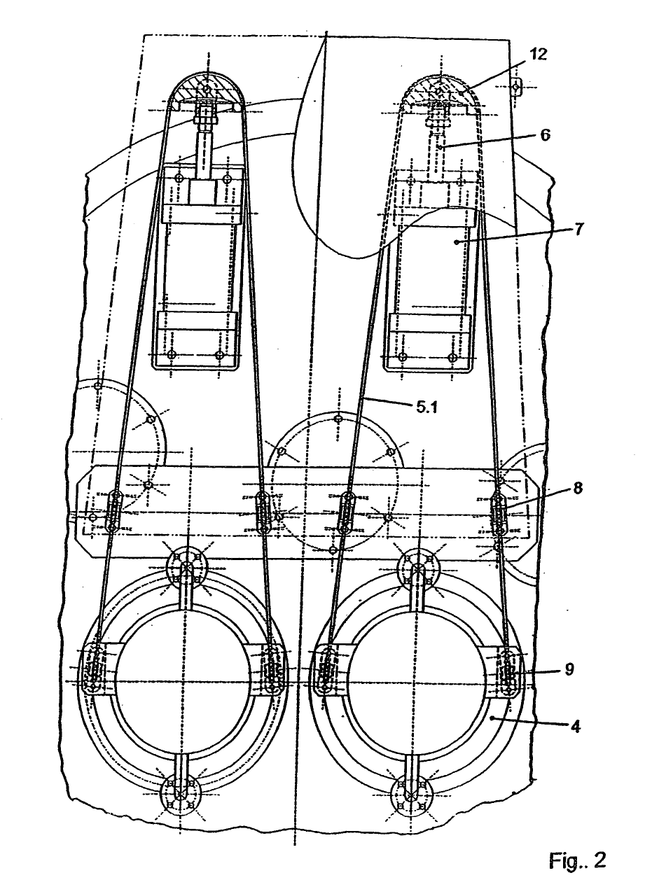

A pull is exerted on the cable pull 5 via the cylinder 7 or the piston rod 6, the deflecting roller 9 being arranged in such a way that the pull takes place axially parallel to the axis A of the shaft 1. As a result, the packing housing 4 is pressed onto the packing stack 3 and consequently the stuffing box effect is achieved. Exactly the same pressure is exerted on the packing stack 3 via the pneumatic cylinder 7, irrespective of the thermal expansions which occur. Even when the volume of the packing pack becomes smaller during cooling, the pressure on the packing pack 3 can be kept the same via the pneumatic cylinder. Corresponding control and checking members for the cylinder 7 are not described in any more detail, since they are commercially available.

Whereas, in the exemplary embodiment according to FIG. 1, either two cable pulls, each with a cylinder, may be provided on each side of the packing housing 4 or else two cable pulls which are connected to only one cylinder, FIG. 2 shows an arrangement in which a cable pull 5.1 is connected at both ends to the packing housing 4 in each case on one side of the latter. This cable pull 5.1 is then laid via a deflection 12 which is acted upon by the piston rod 6 of the cylinder 7. A compensation of different counterpressures on the sides can take place in this way.

In the exemplary embodiment shown, the orientation of the cylinder 7 is different from that in FIG. 1, but the mode of action is similar. Furthermore, a dual-shaft mixing kneader is indicated.

1-9. (cancelled).

10. A device for treating material comprises:
a treatment housing;
a shaft mounted along an axis for rotating within the treatment housing;
bearing means for mounting the shaft for rotation, the bearing means comprises a bearing sleeve located outside the treatment housing;
a packing housing located between the treatment housing and the bearing sleeve;
a packing stack located between the packing housing and the bearing sleeve; and
pressure regulating means connected to the packing housing for controlling the pressure applied to the stacking pack.

11. A device according to claim 10, wherein the packing housing is moved along the shaft axis.

12. The device according to claim 10, wherein the pressure regulating means comprises a regulatable force accumulator.

13. The device according to claim 12, wherein the force accumulator is a pneumatically driven cylinder.

14. The device according to claim 13, wherein the force accumulator is connected to the packing housing by flexible means.

15. The device according to claim 14, wherein the flexible means comprises a cable pull.

16. The device according to claim 15, wherein the cable pull is led by at least one deflecting roller in the manner of a block and tackle.

17. The device according to claim 14, wherein a flexible means is located diagonally opposite to the packing housing.

18. The device according to claim 14, wherein the flexible means is articulated with its ends diagonally opposite on the packing housing, said flexible element being led via a deflection element on the force accumulator.

19. A device according to claim 10 wherein pressure regulating means is connected to the packing housing by a cable pull, the cable pull is led by at least one deflecting roller, wherein the deflecting roller is arranged to apply the pressure axially along the axis of the shaft.

20. A device according to claim 19, wherein the cable pull is provided on diagonally opposite portions of the packing housing.

21. The device according to claim 19, wherein the cable pull is articulated with its ends diagonally opposite on the packing housing, wherein the cable pull passes over a deflection on the force accumulator.
